(19) United States
(12) Patent Application Publication
(10) Pub. No.: US 2022/0268993 A1
(43) Pub. Date: Aug. 25, 2022

(54) THIN FILM OPTICAL WAVEGUIDE AND PREPARATION METHOD THEREFOR

(71) Applicant: IRIXI PHOTONICS (SUZHOU) CO., LTD., Suzhou (CN)

(72) Inventors: Yifan CHEN, Suzhou (CN); Meng HUANG, Suzhou (CN)

(21) Appl. No.: 17/632,808

(22) PCT Filed: Nov. 18, 2020
(86) PCT No.: PCT/CN2020/129664

§ 371 Date: Feb. 4, 2022

(30) Foreign Application Priority Data
Dec. 25, 2019 (CN) 201911360478.4

(51) Int. Cl. G02B 6/12

(52) U.S. Cl. CPC G02B 6/12; G02B 2006/12061; G02B 2006/1213; G02B 2006/12166

(57) ABSTRACT

A thin film optical waveguide includes a silicon-based substrate, a cladding layer arranged on the silicon-based substrate, and an optical waveguide core layer arranged on the silicon-based substrate. The optical waveguide core layer is arranged in the cladding layer, the refractive index of the optical waveguide core layer is higher than that of the cladding layer, the optical waveguide core layer includes a double-layer optical waveguide dielectric thin film and a thin film material interlayer arranged between the double-layer optical waveguide dielectric thin film, the thin film material interlayer has a two-dimensional lattice sub-wavelength structure, and the effective lattice constant and the duty cycle of the two-dimensional lattice sub-wavelength structure are approximately the same in each propagation direction, so as to make the effective refractive index of the thin film optical waveguide approximately isotropic.

### CROSS REFERENCE TO RELATED APPLICATIONS

This application claims priority of Chinese Patent Application No. 201911360478.4, filed Dec. 25, 2019, the entire disclosures of both of which are incorporated herein by reference.

### FIELD OF THE INVENTION

This application relates to a thin film optical waveguide and preparation method therefor.

### DESCRIPTION OF THE PRIOR ART

At present, in the field of optical communication, optical waveguides based on sub-wavelength grating structure are widely concerned due to its advantages of low loss and adjustable effective refractive index. Among them, two-dimensional lattice sub-wavelength thin film waveguide structure has a higher freedom of parametrization than one-dimensional wavelength grating structure, which enables to design the effective refractive index of optical waveguide in a wider range and more accurately, so it has a wide application prospect. The effective refractive index of optical waveguide is one of the important parameters to characterize its performance, which has a great impact on various optoelectronic devices, so it is an important index to determine the material and structure of optical waveguide. For the two-dimensional lattice sub-wavelength thin film waveguide structure, the effective refractive index of light propagating in different directions is different, which affects the performance of some specific optical devices. Meanwhile, for optical devices with bending waveguides, such as micro-ring resonators, the anisotropic effective refractive index is also a challenge for design and process. Taking micro-ring resonators as an example, in order to ensure the same effective refractive index of light propagating in the bending optical waveguide, it is necessary to constantly change the direction of the two-dimensional lattice during the design. Meanwhile, due to the difference between the inner diameter and outer diameter of the micro-ring resonator, the lattice constant and duty cycle of the two-dimensional lattice should be constantly changed on the side near the inner diameter and the side near the outer diameter to maintain the same effective refractive index. In addition to the complexity of the design, the process error may also have a great impact on the device performance during the preparation process.

### BRIEF SUMMARY OF THE INVENTION

The present invention aims to provide a thin film optical waveguide, in which the effective lattice constant and duty cycle of the two-dimensional sub-wavelength structure are approximately the same in all directions, so as to make the effective refractive index of the thin film optical waveguide approximately isotropic.

To achieve the above purposes, the present invention is realized as the follow technical solution:

a thin film optical waveguide including a silicon-based substrate, a cladding layer arranged on the silicon-based substrate, and an optical waveguide core layer arranged on the silicon-based substrate, wherein the optical waveguide core layer is arranged in the cladding layer, the refractive index of the optical waveguide core layer is higher than that of the cladding layer, the optical waveguide core layer comprises a double-layer optical waveguide dielectric thin film and a thin film material interlayer arranged between the double-layer optical waveguide dielectric thin film, the thin film material interlayer has a two-dimensional lattice sub-wavelength structure, and the effective lattice constant and the duty cycle of the two-dimensional lattice sub-wavelength structure are approximately the same in each propagation direction.

Further, the two-dimensional lattice subwavelength structure comprises lattice points, the effective lattice constant and the duty cycle are determined by the shape and length and width of the lattice points.

Further, the lattice points are one of oval, criss-cross, hexagonal, and octagonal.

Further, the two-dimensional lattice sub-wavelength structure is Bravais lattice structure or quasicrystal structure.

Further, the Bravais lattice structure is comprised of square or hexagon.

Further, the shape of the quasicrystal structure is octagon or decagon or dodecagon.

Further, the thin film material interlayer is selected from one of silicon, doped silica, lithium niobate, titanium dioxide, zinc oxide, and magnesium doped zinc oxide.

Further, the optical waveguide dielectric thin film is doped silica.

Further, the doped silica is 2% germanium doped silica.

The invention also provides a preparation method of the thin film optical waveguide, and the preparation method is as follows:

S1, providing a silicon-based substrate, and forming a lower optical waveguide dielectric thin film on the silicon-based substrate;

S2, preparing a thin film material interlayer;

S3, preparing the thin film material interlayer into the two-dimensional lattice sub-wavelength structure, wherein the effective lattice constant and the duty cycle of the two-dimensional lattice sub-wavelength structure are approximately the same in each propagation direction;

S4, preparing an upper layer optical waveguide dielectric thin film, wherein the lower layer optical waveguide dielectric thin film and the upper layer optical waveguide dielectric thin film form the double-layer optical waveguide dielectric thin film;

S5, preparing the cladding layer.

The beneficial effect of the present invention is: because the present invention provides a two-dimensional lattice sub-wavelength structure of thin film optical waveguide with approximately same effective lattice constant and duty cycle in each direction of propagation, it makes the effective refractive index of the thin film optical waveguide approximately isotropic, which overcomes the problem of complex structure and process error in the design of the thin film optical waveguide with two-dimensional lattice sub-wavelength structure. This invention makes the effective refractive index approximately isotropic without additional structural design or change of two-dimensional lattice direction, simplifies the structure of the thin film optical waveguide and ensures the performance of the thin film optical waveguide.

The above description is only an outline of the technical schemes of the present invention. Preferred embodiments of the present invention are provided below in conjunction with the attached drawings to enable one with ordinary skill in the art to better understand said and other objectives, features, and advantages of the present invention and to make the present invention accordingly.

### BRIEF DESCRIPTION OF THE DRAWINGS

FIG. 1 is a structural diagram depicting the thin film optical waveguide with a two-dimensional lattice sub-wavelength in one embodiment of the present invention.

FIG. 2 is a structural diagram depicting incident light enters the thin film optical waveguide of FIG. 1 in 0° direction.

FIG. 3 is a structural diagram depicting the criss-cross lattice points in FIG. 1.

FIG. 4 is a structural diagram depicting incident light enters the thin film optical waveguide of FIG. 1 in 45° direction.

FIG. 5 shows the effective refractive index of two-dimensional lattice sub-wavelength optical waveguide of planar square Bravais lattice in each direction.

FIG. 6 shows the relationship between the effective refractive index difference of incident light in direction 0° and 45° and the length of the criss-cross lattice points.

FIG. 7 shows the relationship between the effective refractive index difference of incident light in direction 0° and 45° and the width of the criss-cross lattice points.

### DETAILED DESCRIPTION OF THE PREFERRED EMBODIMENTS

Specific embodiments of the present invention are described in further detail in combination with the related drawings and embodiments below. However, in addition to the descriptions given below, the present invention can be applied to other embodiments, and the scope of the present invention is not limited by such, rather by the scope of the claims.

In the description of the invention, it should be noted that the orientation or position relations indicated by the terms “center”, “up”, “down”, “left”, “right”, “vertical”, “horizontal”, “inside” and “outside” are based on the orientation or position relations shown in the attached drawings for the convenience of describing the invention and simplifying the description, rather than indicate or imply the mechanisms or elements must be constructed and operated in the particular orientation and shall not be construed as a limitation of the invention. In addition, the terms “first”, “second” and “third” are used for descriptive purposes only and are not to be understood to indicate or imply relative importance.

In the description of the invention, it should be noted that, unless otherwise expressly specified and qualified, the terms “mounting”, “connecting” and “connection” should be understood in a broad sense, for example, a fixed connection, a detachable connection, or an integrated connection; It can be mechanical or electrical; It can be directly connected or indirectly connected with an intermediary. It can be connected within two components. For ordinary technicians in the field, the specific meanings of the above terms in the present invention can be understood on a case-by-case basis.

Furthermore, the technical features involved in the different embodiments of the invention described below may be combined with each other provided that they do not conflict with each other.

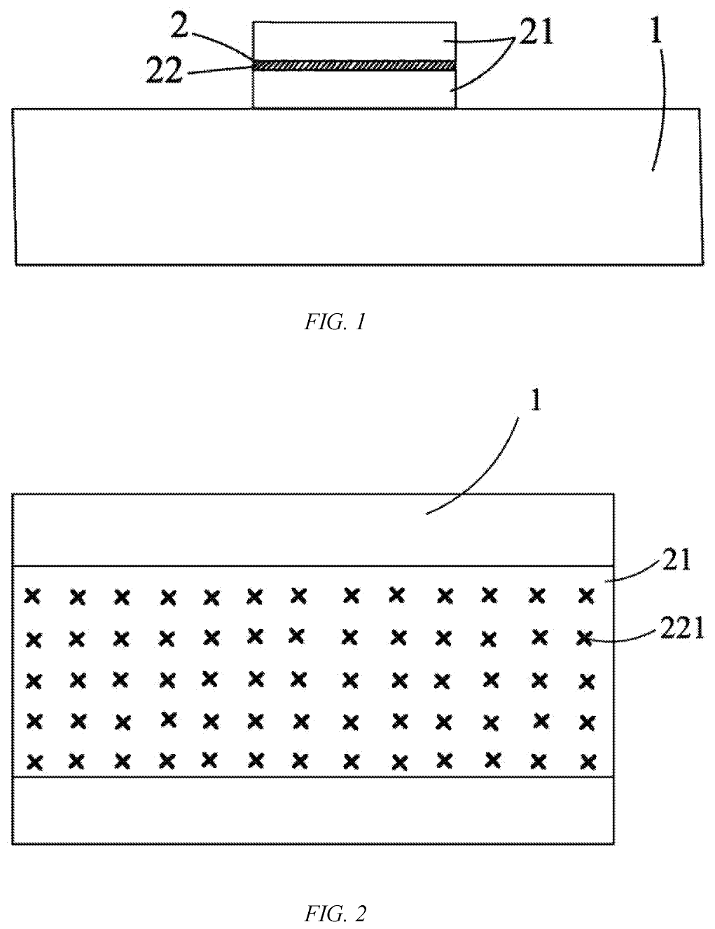

Referring to FIG. 1 and FIG. 2, the thin-film optical waveguide shown in an embodiment of the present invention includes a silicon-based substrate 1, an optical waveguide core layer 2 arranged on the silicon-based substrate 1, and a cladding layer (not shown) arranged on the silicon-based substrate 1. The optical waveguide core layer 2 is arranged in the cladding layer, and the refractive index of the optical waveguide core layer 2 is higher than that of the cladding layer. Specifically, the optical waveguide core layer 2 includes a double-layer optical waveguide dielectric thin film 21 with the same thickness and a thin film material interlayer 22 arranged between the double-layer optical waveguide dielectric thin film 21. The optical waveguide dielectric thin film 21 generally uses doped silica. The thin film material interlayer 22 is generally selected from one of silicon, doped silicon dioxide and lithium niobate common materials or titanium dioxide, zinc oxide and magnesium doped zinc oxide negative thermal-optical coefficient materials.

The thin film material interlayer 22 is a two-dimensional lattice sub-wavelength structure, and the effective lattice constant and duty cycle of the two-dimensional lattice sub-wavelength structure are approximately the same in each propagation direction. The two-dimensional lattice sub-wavelength structure is Bravais lattice structure or quasicrystal structure, the Bravais lattice comprised of square or hexagons, and the shape of the quasicrystal structure is octagon or decagon or dodecagon. Please refer to FIG. 2, the two-dimensional lattice array is an abstract diagram, the lattice points 221 is the location of the centroid of the crystal cell, and the lattice constant ∧ is the side length of the crystal cell, which can be regarded as the distance between two adjacent lattice points 221 in FIG. 2. The lattice points 211 is one of oval, criss-cross, hexagonal and octagonal.

In this embodiment, the thin film optical waveguide is prepared from a silica substrate 1, a double-layer optical waveguide dielectric thin film 21 with 2% germanium doped silica, a titanium dioxide thin film material interlayer 22, and a silica cladding layer, wherein the titanium dioxide thin film material interlayer 22 is a two-dimensional lattice subwavelength structure with square Bravais lattice, and the lattice points 221 is in shape of criss-cross.

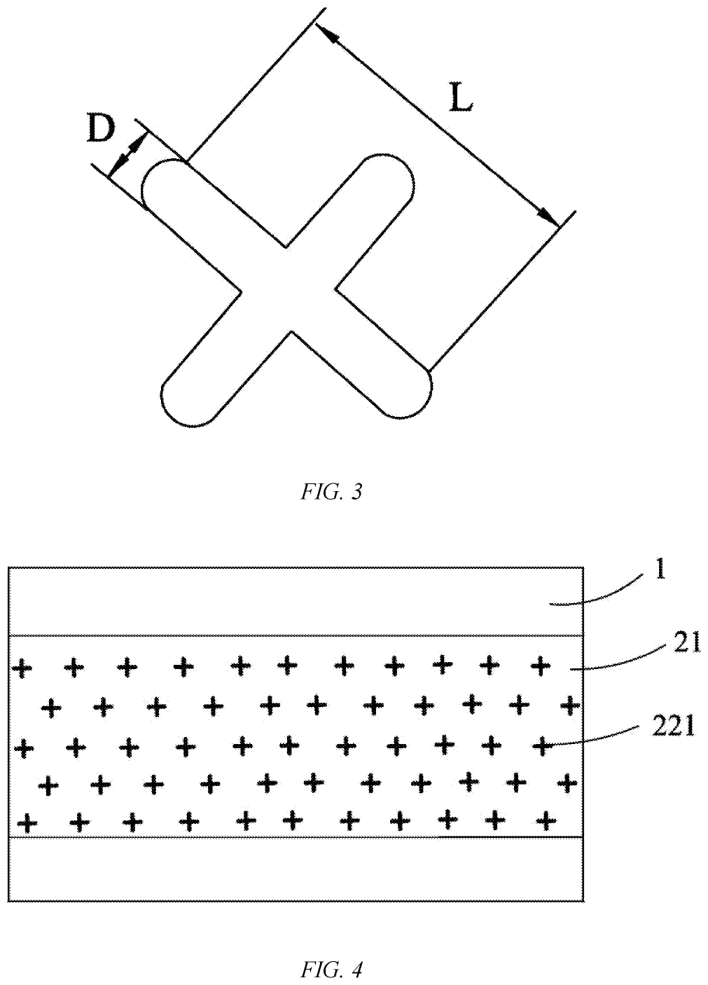

Next, taking the lattice points 221 with shape of criss-cross as an example to illustrate in detail that how to make the effective lattice constant and duty cycle approximately the same in each propagation direction, so that the effective refractive index of the thin film optical waveguide is approximately isotropic. Referring to FIG. 3, the criss-cross lattice points 211 has a length L and a width D.

The optical waveguide dielectric thin film 21 of the thin film optical waveguide is the main optical waveguide structure to ensure the single-mode operation. The two-dimensional lattice sub-wavelength structure formed in the thin film material interlayer 22 can be regarded as a single-mode optical waveguide structure with homogeneous medium.

In the design of the thin film optical waveguide structure, this embodiment is guided by Scalar Heimholtz formula, that is:

∇²Ψ(x, y, z)+k₀²n²(x, y)Ψ(x, y, z)=0

Where, Ψ can be any field component, k₀ is the vacuum wave number, n is the refractive index, z direction is the propagation direction, x and y are the vertical and horizontal directions of the cross section respectively. In order to obtain the solution of this formula, it can be simplified by the effective refractive index method as follows:

$$\frac{1}{F ( x , y )} \frac{{δ}^{2} F}{δ {x}^{2}} + {k}_{0}^{2} {n}^{2} ( x , y ) = {k}_{0}^{2} {n}_{eff}^{2} ( y ) \\ \frac{1}{G ( y )} \frac{{d}^{2} G}{{dy}^{2}} - {β}^{2} = - {k}_{0}^{2} {n}_{eff}^{2} ( y )$$

Where, F and G are mode field distributions, n_{eff} is the effective refractive index, β is the propagation constant. The propagation constant and effective refractive index of the optical waveguide can be calculated by this method.

Taking square Bravais lattice structure and circular lattice points as an example, the reason for the effective refractive index anisotropy of two-dimensional lattice sub-wavelength thin film optical waveguides is that the effective lattice constants and duty cycles of light propagating in different directions are different, resulting in different effective refractive indexes. The use of quasicrystal structures such as octagonal, decagonal or dodecagonal can reduce the degree of anisotropy in a certain range, but the finite width of optical waveguide makes the quasicrystal structure unable to further achieve isotropy.

Since the effective lattice constant and the duty cycle are determined by the shape, the length and the width of the lattice points 221, therefore, by adjusting the shape, the length and the width of the lattice points 221, the effective lattice constant and duty cycle of the two-dimensional lattice sub-wavelength structure could be approximately the same in each propagation direction, so that the effective refractive index of the thin film optical waveguide is approximately isotropic. Now, taking the thin film optical waveguide shown in this embodiment as an example, the wavelength of the incident light is selected as 1550 nm.

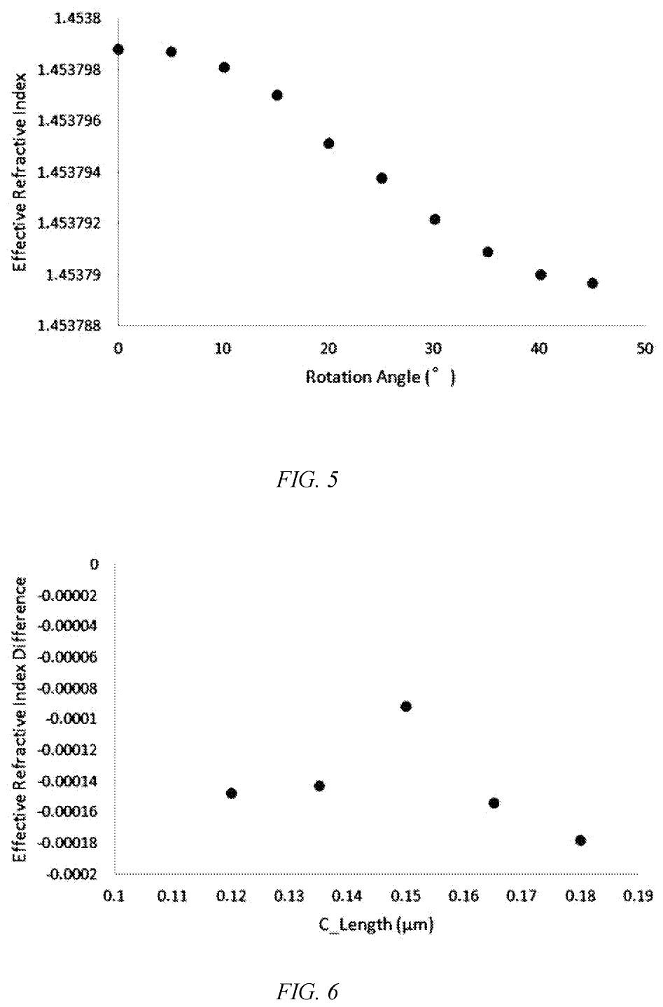

Because of the symmetry of the square Bravais lattice, only the effective refractive index in the propagation direction of 0°-45° needs to be considered. Referring to FIG. 5, through the simulation of the effective refractive index of the two-dimensional lattice sub-wavelength optical waveguide of the planar square Bravais lattice in each direction, it can be seen that the difference between the effective refractive index of the two-dimensional lattice optical waveguide and the two directions of 0° and 45° is the largest. Therefore, in this embodiment, only the effective refractive index in the directions of 0° and 45° needs to be considered.

Please refer to FIG. 2 and FIG. 4, the direction and position of the criss-cross lattice points of the square Bravais lattice encountered by the incident light entering the thin film optical waveguide at 0° and 45° are different, and the corresponding effective lattice constant and duty cycle are different.

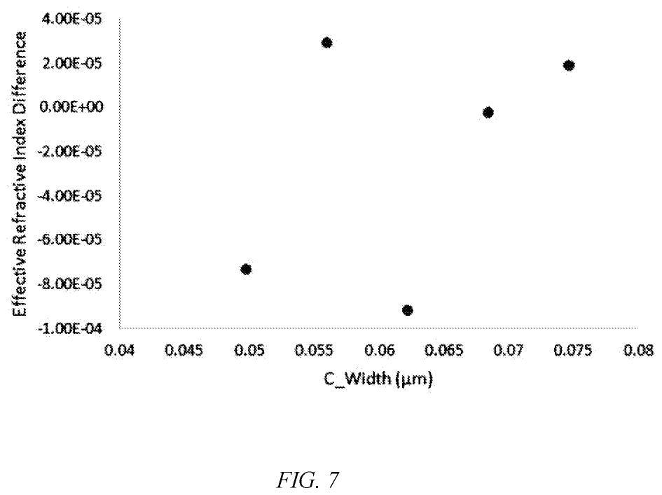

Fine tuning the length L of the criss-cross lattice points 211, the relationship between the difference of the effective refractive index of the incident light in the directions of 0° and 45° and the length L of the criss-cross points is shown in FIG. 6; fine tuning the width D of the criss-cross lattice points 211, the relationship between the effective refractive index difference of the incident light in direction 0° and 45° and the width D of the criss-cross lattice points 211 is shown in FIG. 7. The maximum difference of the effective refractive index in the two directions of 0° and 45° is less than 0.0002. According to the symmetry of the square Bravais lattice, the effective refractive indexes in all directions are approximately the same, which meets the requirement of effective refractive index approximately isotropy.

The present invention optimizes the length and the width of the lattice points in the two-dimensional lattice, makes the effective refractive index difference between the two incidence directions with the largest effective refractive index difference in the two-dimensional lattice approximately the same according to the symmetry of the two-dimensional lattice. The effective lattice constant and duty cycle remain roughly the same in different propagation directions at this time, meeting the requirement of approximate isotropic. This method can be applied to any thin film optical waveguides formed by any symmetrical two-dimensional lattice structure (hexagonal, octagonal, decagonal, dodecagonal, etc.) and related lattice points (hexagonal, octagonal, decagonal, dodecagonal, etc.).

The invention also provides a preparation method for preparing the thin film optical waveguide, and the preparation method is as follows:

S1, providing the silicon-based substrate 1, specifically silica substrate 1, coating the doped silica on the silica substrate 1 by PECVD (Plasma Enhanced Chemical Vapor Deposition) to form a lower optical waveguide dielectric thin film, in which the doped silica material is 2% germanium doped silica;

S2, preparing a thin film material interlayer 22 with titanium dioxide material by ALD (Atomic Layer Deposition);

S3, making the titanium dioxide thin film material interlayer into the two-dimensional lattice sub-wavelength structure by NIL (Nanoimprint Lithography) or electronbeam lithography or optical lithography, wherein, the effective lattice constant and duty cycle of the two-dimensional lattice sub-wavelength structure are approximately the same in all directions;

S4, coating 2% germanium doped silica material by PECVD to prepare the upper optical waveguide dielectric thin film, the lower optical waveguide dielectric thin film and the upper optical waveguide dielectric thin film form the double-layer optical waveguide dielectric film 21;

S5, preparing a silica cladding layer on the outer circumference of the double-layer optical waveguide dielectric film 21 and the thin film material interlayer 22.

To sum up, because of the present invention provides a two-dimensional lattice sub-wavelength structure of thin film optical waveguide effective lattice constant and duty cycle on the direction of propagation approximation, so as to make the effective refractive index of the thin film optical waveguide approximately isotropic, which overcomes the problem of complex structure and process error in the design of the thin film optical waveguide with two-dimensional lattice sub-wavelength structure. It makes the effective refractive index approximately isotropic without additional structural design or change of two-dimensional lattice direction, simplifies the structure of the thin film optical waveguide and ensures the performance of the thin film optical waveguide.

The technical features of the above embodiments can be combined arbitrarily, in order to make the description concise, not all possible combinations of the technical features in the above embodiments are described. However, as long as there is no contradiction between the combination of these technical features, they shall be considered to be within the scope of this specification.

The present invention only described several above embodiments, which are described more specific and detailed, but it cannot be understood as a limitation on the scope of the present invention. It should be pointed out that for ordinary technical personnel in the art, without departing from the concept of the present invention, a number of deformation and improvements can be made, which belong to the scope of the present invention. Therefore, the scope of the present invention shall be subject to the recorded claims.

1. A thin film optical waveguide, including a silicon-based substrate and a cladding layer arranged on the silicon-based substrate, and is characterized by further including an optical waveguide core layer arranged on the silicon-based substrate, wherein the optical waveguide core layer is arranged in the cladding layer, the refractive index of the optical waveguide core layer is higher than that of the cladding layer, the optical waveguide core layer comprises a double-layer optical waveguide dielectric thin film and a thin film material interlayer arranged between the double-layer optical waveguide dielectric thin film, the thin film material interlayer has a two-dimensional lattice sub-wavelength structure, and the effective lattice constant and the duty cycle of the two-dimensional lattice sub-wavelength structure are approximately the same in each propagation direction.

2. The thin film optical waveguide according to claim 1, characterized in that the two-dimensional lattice subwavelength structure comprises lattice points, the effective lattice constant and the duty cycle are determined by the shape and length and width of the lattice points.

3. The thin film optical waveguide according to claim 1, characterized in that the lattice points are one of oval, criss-cross, hexagonal, and octagonal.

4. The thin film optical waveguide according to claim 1, characterized in that the two-dimensional lattice sub-wavelength structure is Bravais lattice structure or quasicrystal structure.

5. The thin film optical waveguide according to claim 4, characterized in that the Bravais lattice structure is comprised of square or hexagon.

6. The thin film optical waveguide according to claim 4, characterized in that the shape of the quasicrystal structure is octagon or decagon or dodecagon.

7. The thin film optical waveguide according to claim 1, characterized in that the thin film material interlayer is selected from one of silicon, doped silica, lithium niobate, titanium dioxide, zinc oxide, and magnesium doped zinc oxide.

8. The thin film optical waveguide according to claim 1, characterized in that the optical waveguide dielectric thin film is doped silica.

9. The thin film optical waveguide according to claim 8, characterized in that the doped silica is 2% germanium doped silica.

10. A preparation method of the thin film optical waveguide according to claim 1, characterized in that the preparation method is as follows:
S1, providing a silicon-based substrate, and forming a lower optical waveguide dielectric thin film on the silicon-based substrate;
S2, preparing a thin film material interlayer;
S3, preparing the thin film material interlayer into the two-dimensional lattice sub-wavelength structure, wherein the effective lattice constant and the duty cycle of the two-dimensional lattice sub-wavelength structure are approximately the same in each propagation direction;
S4, preparing an upper layer optical waveguide dielectric thin film, wherein the lower layer optical waveguide dielectric thin film and the upper layer optical waveguide dielectric thin film form the double-layer optical waveguide dielectric thin film;
S5, preparing the cladding layer.
